(19) United States
(12) Patent Application Publication
(10) Pub. No.: US 2020/0159366 A1
(43) Pub. Date: May 21, 2020

(54) OPERATION SUPPORT DEVICE AND OPERATION SUPPORT METHOD

(71) Applicant: Mitsubishi Electric Corporation, Tokyo (JP)

(72) Inventors: Yuji MATSUDA, Tokyo (JP); Naohiko OBATA, Tokyo (JP); Mitsuo SHIMOTANI, Tokyo (JP); Tadashi MIYAHARA, Tokyo (JP)

(73) Assignee: Mitsubishi Electric Corporation, Tokyo (JP)

(21) Appl. No.: 16/611,373

(22) PCT Filed: Jul. 21, 2017
(86) PCT No.: PCT/JP2017/026448

§ 371 Date: Nov. 6, 2019

(51) Int. Cl. G06F 3/041; G06F 3/0488; G06F 3/01; G06F 3/14; G10L 15/08; G10L 15/22; B60K 35/00

(52) U.S. Cl. CPC G06F 3/0418; G06F 3/04883; G06F 3/013; G06F 3/1423; G10L 15/08; G10L 15/22; B60K 2370/156; G06F 2203/0381; G10L 2015/223; G10L 2015/088; B60K 2370/736; B60K 2370/146; B60K 2370/148; B60K 35/00

(57) ABSTRACT

The present invention has an object to provide a technology of accurately identifying a device that a driver desires to operate out of on-board devices, and supporting operation of the device. An operation support device of the present invention includes a line of sight direction acquisition unit, a characteristic behavior acquisition unit, a device identification unit, and a display controller. The device identification unit is configured to identify at least one on-board device out of a plurality of on-board devices mounted in the vehicle as an operation target device that the driver desires to operate, based on a line of sight direction and a characteristic behavior. The display controller is configured to cause a display device mounted in the vehicle to display an operation screen of the operation target device.

### TECHNICAL FIELD

The present invention relates to an operation support device and an operation support method.

### BACKGROUND ART

As a technology of supporting driver's operation on an on-board device, there is a technology of detecting a line of sight of a driver and using the line of sight as a command of device operation. For example, Patent Document 1 discloses a system as its fourth embodiment. In the system, a line of sight of a driver is detected, and operation regarding a device that the driver sees is performed with a remote operation device. Specifically, in the system of Patent Document 1, a vehicle interior area including a line of sight direction of a user is identified, the identified area and disposition information of on-board devices are compared, and an on-board device disposed in the line of sight direction of the user is identified.

### PRIOR ART DOCUMENTS

### Patent Documents

Patent Document 1: Japanese Patent Application Laid-Open No. 2016-110424

### SUMMARY

### Problem to be Solved by the Invention

In the technology of Patent Document 1, an on-board device is identified based only on the line of sight. The line of sight of a driver is subject to influence from vibration of a vehicle and limitation of a gaze time period during driving of a vehicle, for example. Thus, there has been a problem in that accuracy of identification is not always high.

In the light of the problem described above, the present invention has an object to provide a technology of accurately identifying a device that a driver desires to operate out of on-board devices, and supporting operation of the device.

### Means to Solve the Problem

An operation support device of the present invention includes a line of sight direction acquisition unit, a characteristic behavior acquisition unit, a device identification unit, and a display controller. The line of sight direction acquisition unit is configured to acquire a line of sight direction of a driver of a vehicle. The characteristic behavior acquisition unit is configured to acquire a characteristic behavior being a characteristic behavior of the driver other than a line of sight. The device identification unit is configured to identify at least one on-board device out of a plurality of on-board devices mounted in the vehicle as an operation target device that the driver desires to operate, based on the line of sight direction and the characteristic behavior. The display controller is configured to cause a display device mounted in the vehicle to display an operation screen of the operation target device.

### Effects of the Invention

An operation support device of the present invention includes a line of sight direction acquisition unit, a characteristic behavior acquisition unit, a device identification unit, and a display controller. The line of sight direction acquisition unit is configured to acquire a line of sight direction of a driver of a vehicle. The characteristic behavior acquisition unit is configured to acquire a characteristic behavior being a characteristic behavior of the driver other than a line of sight. The device identification unit is configured to identify at least one on-board device out of a plurality of on-board devices mounted in the vehicle as an operation target device that the driver desires to operate, based on the line of sight direction and the characteristic behavior. The display controller is configured to cause a display device mounted in the vehicle to display an operation screen of the operation target device. Therefore, according to the operation support device of the present invention, a device that a driver desires to operate can be accurately identified out of on-board devices, and operation of the device can be supported.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram illustrating a configuration of an operation support device according to a first embodiment.

FIG. 2 is a flowchart illustrating operation of the operation support device according to the first embodiment.

FIG. 3 is a block diagram illustrating a configuration of an operation support device according to a second embodiment.

FIG. 4 is a block diagram illustrating a configuration of a characteristic behavior detector according to the second embodiment.

FIG. 5 is a diagram illustrating a plurality of displays provided in a vehicle interior.

FIG. 6 is a diagram illustrating a state in which an operation menu of a navigation device is displayed on a map around a subject vehicle position on a CID.

FIG. 7 is a diagram illustrating a state in which a tutorial of a navigation device is displayed on a map around a subject vehicle position on the CID.

FIG. 8 is a diagram illustrating a state in which a function explanatory screen of a navigation device is displayed on a map around a subject vehicle position on the CID.

FIG. 9 is a flowchart illustrating operation of the operation support device according to the second embodiment.

FIG. 10 is a flowchart illustrating operation of the operation support device according to the second embodiment.

FIG. 11 is a flowchart illustrating details of Step S305 of FIG. 10.

FIG. 12 is a diagram illustrating a state in which operation screens of a navigation device and an audio device are displayed on a display device.

FIG. 13 is a diagram illustrating the display device and an operation device.

FIG. 14 is a diagram illustrating a characteristic behavior of a driver.

FIG. 15 is a diagram illustrating a state in which an operation screen of an air conditioner is displayed on the display device.

FIG. 16 is a diagram illustrating a characteristic behavior of a driver.

FIG. 17 is a diagram illustrating a state in which a volume operation screen of an audio device is displayed on the display device.

FIG. 18 is a diagram illustrating a characteristic behavior of a driver.

FIG. 19 is a diagram illustrating a state in which a track skip forward/backward screen of an audio device is displayed on the display device.

FIG. 20 is a diagram illustrating a characteristic behavior of a driver.

FIG. 21 is a diagram illustrating a state in which an operation menu of a navigation device is displayed on the display device.

FIG. 22 is a flowchart illustrating operation of an operation support device according to a third embodiment.

FIG. 23 is a block diagram illustrating a configuration of an operation support device according to a fourth embodiment.

FIG. 24 is a diagram illustrating a hardware configuration of the operation support device.

FIG. 25 is a diagram illustrating a hardware configuration of the operation support device.

FIG. 26 is a diagram illustrating a configuration example of the operation support device according to the second and third embodiments consisting of a vehicle and a server.

### DESCRIPTION OF EMBODIMENTS

### A. First Embodiment

<A-1. Configuration>

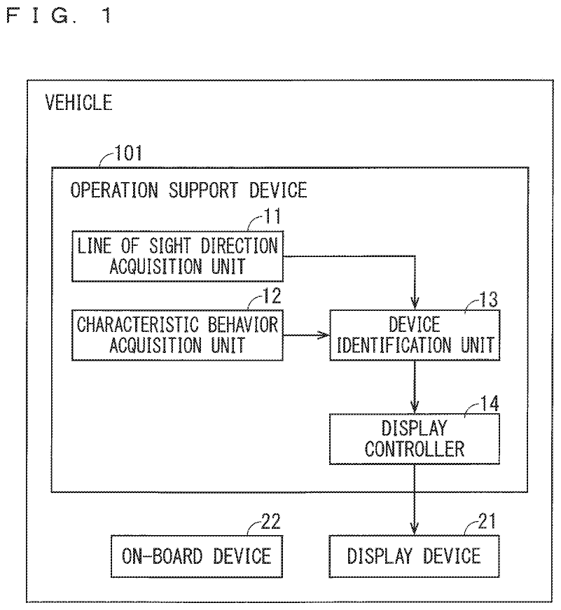

FIG. 1 is a block diagram illustrating a configuration of an operation support device 101 according to a first embodiment. The operation support device 101 supports driver's operation on an on-board device 22 mounted in a vehicle. In each embodiment of this Specification, the Wail “vehicle” refers to a vehicle in which the on-board device 22 serving as an operation support target of the operation support device of the embodiment is mounted. Further, if the vehicle in which the on-board device 22 is mounted needs to be distinguished from another vehicle, the former vehicle is referred to as a “subject vehicle” and the latter vehicle is referred to as “another vehicle” or a “nearby vehicle”, for example.

In FIG. 1, the operation support device 101 is illustrated as a device mounted in a vehicle. However, this is merely an example. As will be described later in <E. Hardware Configuration>, a configuration of each part of the operation support device 101 may be distributed in a part other than the vehicle.

The operation support device 101 includes a line of sight direction acquisition unit 11, a characteristic behavior acquisition unit 12, a device identification unit 13, and a display controller 14. A display device 21 is an on-board display. Examples of the display device 21 include a display in an instrument panel, a head-up display (abbreviated as HUD), and a meter display. One or more display devices 21 may be provided.

The line of sight direction acquisition unit 11 acquires a line of sight direction of a driver of a vehicle.

The characteristic behavior acquisition unit 12 acquires a characteristic behavior, which is a characteristic behavior of the driver other than a line of sight. Examples of the characteristic behavior include a driver's finger pointing, gesture, speaking, facial motion, and change in facial expression, or a combination of these.

The device identification unit 13 identifies at least one on-board device 22 out of a plurality of on-board devices 22 mounted in the vehicle as an operation target device that a user desires to operate, based on the line of sight direction and the characteristic behavior.

The display controller 14 causes the display device 21 mounted in the vehicle to display an operation screen of the operation target device. The operation screen is a screen directly or indirectly used for operation of the operation target device. Examples of the operation screen include a screen for displaying an operation menu, a screen for displaying an operation tutorial, and a function explanatory screen of the operation target device.

<A-2. Operation>

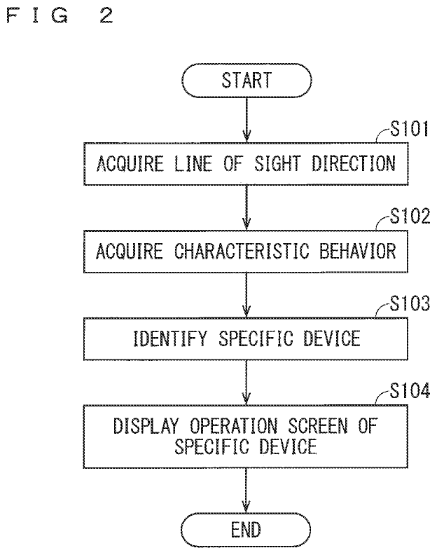

FIG. 2 is a flowchart illustrating operation of the operation support device 101. Operation of the operation support device 101 will be described below, according to the flow of FIG. 2.

First, the line of sight direction acquisition unit 11 determines a line of sight direction of a driver of a vehicle (Step S101). Next, the characteristic behavior acquisition unit 12 acquires a characteristic behavior (Step S102). Next, the device identification unit 13 identifies at least one on-board device 22 out of a plurality of on-board devices 22 as an operation target device, based on the line of sight direction and the characteristic behavior (Step S103). Next, the display controller 14 causes the display device 21 mounted in the vehicle to display an operation screen of the operation target device (Step S104). This ends the operation of the operation support device 101.

In the flow of FIG. 2, the operation support device 101 acquires a characteristic behavior after acquiring a line of sight direction. However, the order of these processes is arbitrary. Either of the processes may be performed first, or both of the processes may be performed at the same time.

<A-3. Effect>

An operation support device 101 of the first embodiment includes a line of sight direction acquisition unit 11, a characteristic behavior acquisition unit 12, a device identification unit 13, and a display controller 14. The line of sight direction acquisition unit 11 is configured to acquire a line of sight direction of a driver of a vehicle. The characteristic behavior acquisition unit 12 is configured to acquire a characteristic behavior being a characteristic behavior of the driver other than a line of sight. The device identification unit 13 is configured to identify at least one on-board device 22 out of a plurality of on-board devices 22 mounted in the vehicle as an operation target device that the driver desires to operate, based on the line of sight direction and the characteristic behavior. The display controller 14 is configured to cause a display device 21 mounted in the vehicle to display an operation screen of the operation target device. Therefore, according to the operation support device 101 of the first embodiment, the operation target device can be accurately identified, based not only on the line of sight direction but also on the characteristic behavior. Further, the operation screen can be used for driver's operation by causing the operation screen of the operation target device to be displayed on the display device 21.

An operation support method of the first embodiment includes the following steps. One step is to acquire a line of sight direction of a driver of a vehicle. One step is to acquire a characteristic behavior being a characteristic behavior of the driver other than a line of sight. One step is to identify at least one on-board device 22 out of a plurality of on-board devices 22 mounted in the vehicle as an operation target device that the driver desires to operate, based on the line of sight direction and the characteristic behavior. One step is to cause a display device 21 mounted in the vehicle to display an operation screen of the operation target device. Therefore, according to the operation support method of the first embodiment, the operation target device can be accurately identified, based not only on the line of sight direction but also on the characteristic behavior. Further, the operation screen can be used for driver's operation by causing the operation screen of the operation target device to be displayed on the display device 21.

### B. Second Embodiment

<B-1. Configuration>

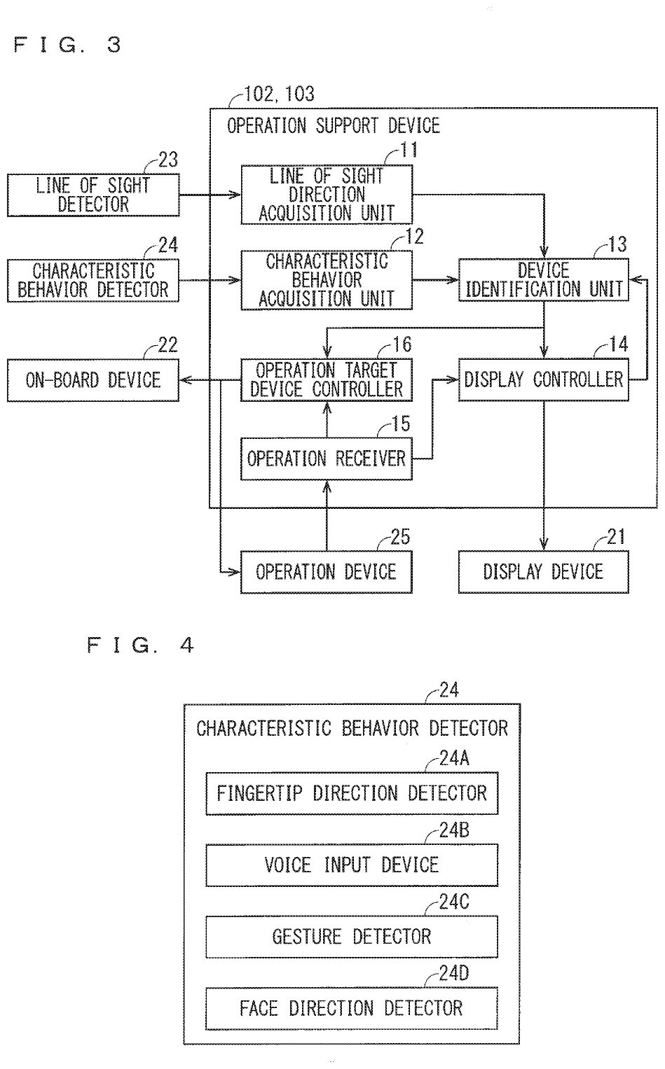

FIG. 3 is a block diagram illustrating a configuration of an operation support device 102 according to a second embodiment. The operation support device 102 includes an operation receiver 15 and an operation target device controller 16, in addition to the configuration of the operation support device 101 according to the first embodiment. Further, the operation support device 102 is connected to an on-board device 22, a line of sight detector 23, a characteristic behavior detector 24, and an operation device 25, and is configured to be capable of using these connected components.

The line of sight detector 23, the characteristic behavior detector 24, and the operation device 25 are mounted in the vehicle.

The operation device 25 is a device for operating an operation screen of the on-board device 22 displayed on the display device 21. Examples of the operation device 25 include a touch pad and a joystick.

The line of sight detector 23 includes a camera, for example. The line of sight detector 23 detects a line of sight direction of a driver, based on an image of a face of the driver captured by the camera. The line of sight direction acquisition unit 11 acquires the line of sight direction of the driver from the line of sight detector 23, and outputs the line of sight direction to the device identification unit 13.

The characteristic behavior detector 24 detects a characteristic behavior of the driver. As illustrated in FIG. 4, the characteristic behavior detector 24 includes a fingertip direction detector 24A, a voice input device 24B, a gesture detector 24C, and a face direction detector 24D.

The fingertip direction detector 24A includes a camera that captures a vehicle interior, for example. The fingertip direction detector 24A detects a finger pointing behavior of the driver as a characteristic behavior, based on an image of a finger of the driver captured by the camera. If the driver performs finger pointing, the fingertip direction detector 24A detects a fingertip direction.

The voice input device 24B includes a microphone mounted in a vehicle interior, for example. The voice input device 24B acquires speaking of the driver through the microphone. In the voice input device 24B, specific keywords are registered. If the speaking voice of the driver includes a specific keyword, the voice input device 24B detects the speaking as a characteristic behavior.

The gesture detector 24C includes a camera that captures a vehicle interior, for example. The gesture detector 24C acquires an image of the driver captured by the camera. In the gesture detector 24C, specific gestures are registered. If a motion of the driver corresponds to a specific gesture, the gesture detector 24C detects the gesture as a characteristic behavior.

The face direction detector 24D includes a camera that captures a vehicle interior, for example. The face direction detector 24D detects a face direction of the driver, based on an image of the driver captured by the camera. For example, if the face of the driver is continuously directed in one direction for a certain period of time, or if the face direction suddenly moves and then stays in a certain direction, the face direction detector 24D detects the face direction in such a case as a characteristic behavior.

Note that the characteristic behavior detector 24 only needs to include at least any of the fingertip direction detector 24A, the voice input device 24B, the gesture detector 24C, and the face direction detector 24D.

The characteristic behavior acquisition unit 12 acquires the characteristic behavior from the characteristic behavior detector 24, and outputs the characteristic behavior to the device identification unit 13.

The device identification unit 13 acquires the line of sight direction from the line of sight direction acquisition unit 11 and the characteristic behavior from the characteristic behavior detecting unit 12, and identifies an operation target device that the driver desires to operate out of the on-board devices 22, based on the line of sight direction and the characteristic behavior. If the device identification unit 13 cannot uniquely identify an operation target device, the device identification unit 13 need not necessarily identify only one operation target device, and may identify a plurality of operation target devices that may be considered to be the true operation target device. Details of processing of identifying an operation target device performed by the device identification unit 13 will be described later in <B-2>.

Examples of the on-board device 22 include a navigation device, an air conditioner, and an audio device. In FIG. 3, the display device 21 and the operation device 25 are illustrated as devices other than the on-board device 22. In FIG. 3, among the devices mounted in the vehicle, a device to be controlled by the operation support device 102 is illustrated as an on-board device 22. Thus, if the driver desires to perform setting change operation of the display device 21 or the operation device 25, for example, these devices may also be an on-board device 22.

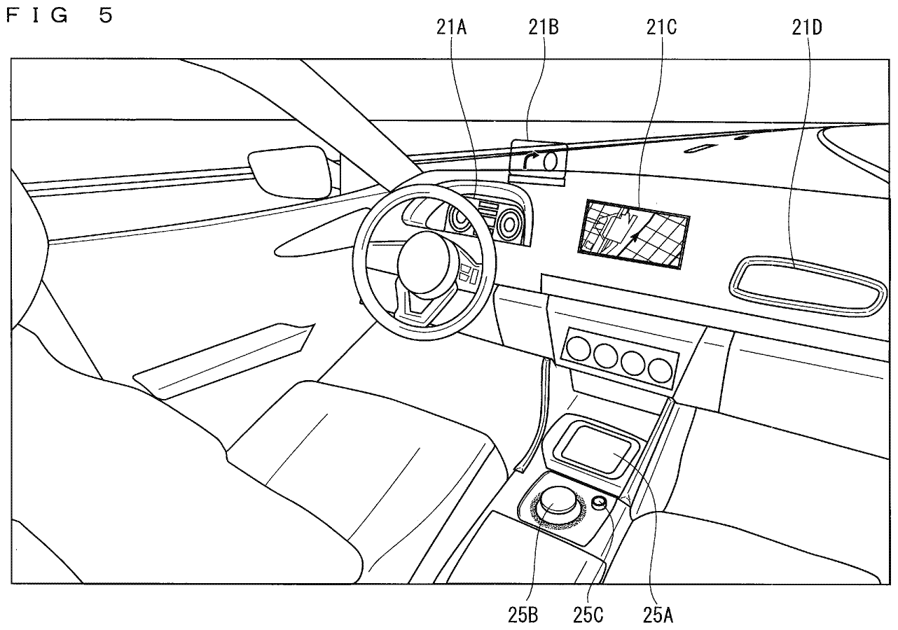

In FIG. 5, a plurality of displays provided in a vehicle interior are illustrated. As illustrated in FIG. 5, if a meter display 21A, a HUD 21B, a center information display (abbreviated as CID) 21C, and a front passenger seat display 21D are provided in the vehicle interior, the display device 21 may be a part or all of the plurality of displays.

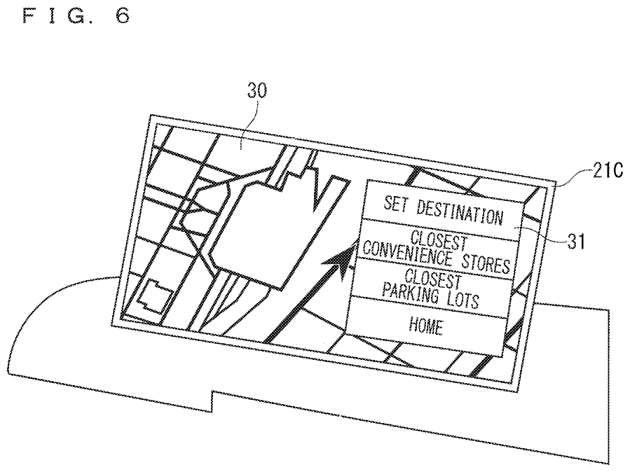

The display controller 14 creates an operation screen of the operation target device, and causes the display device 21 to display the operation screen. FIG. 6 illustrates a state in which an operation menu 31 of a navigation device being an operation target device is displayed on a map around a subject vehicle position 30 on the CID 21C. The driver can perform operation of the navigation device by operating the operation menu 31. Specifically, the operation menu 31 is a screen directly used for operation of the navigation device.

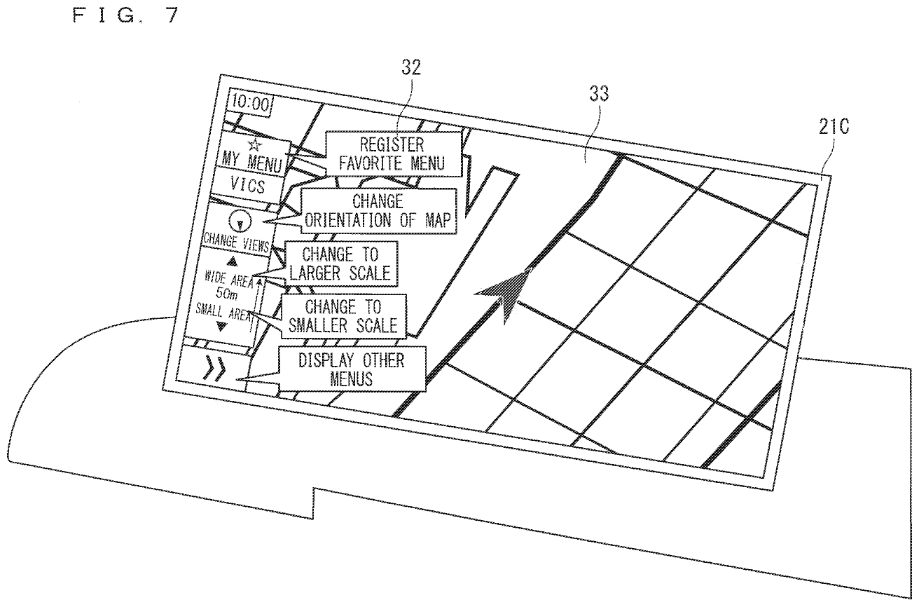

FIG. 7 illustrates a state in which a tutorial 32 of a navigation device being an operation target device is displayed on a map around a subject vehicle position 33 on the CID 21C. The driver can perform operation of the navigation device by following the tutorial 32 and operating a screen. Specifically, the tutorial 32 is a screen directly used for operation of the navigation device.

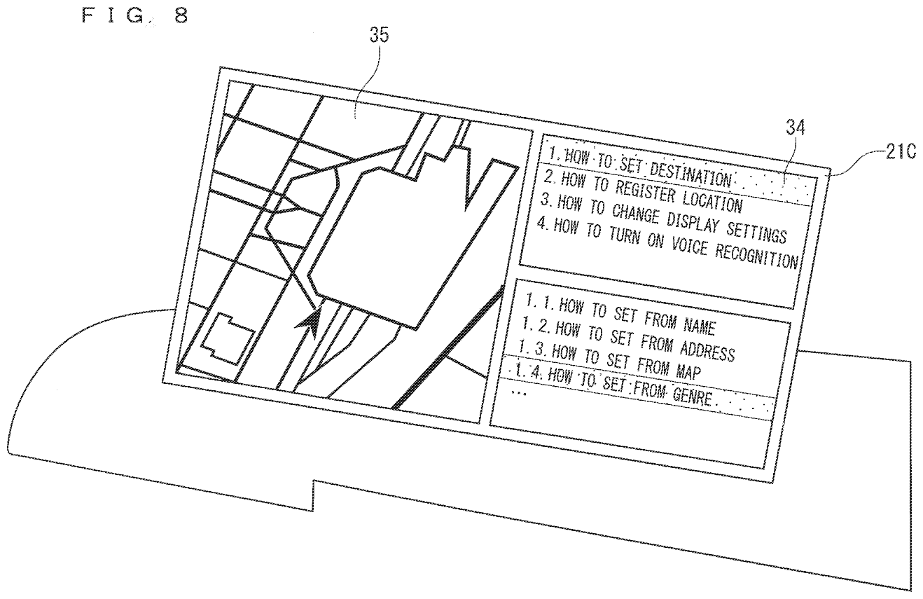

FIG. 8 illustrates a state in which a function explanatory screen 34 of a navigation device being an operation target device is displayed on a map around a subject vehicle position 35 on the CID 21C. The driver can perform operation of the navigation device by reading a description of the function explanatory screen 34, learning how to operate the navigation device, and following the procedure described in the function explanatory screen 34. Thus, the function explanatory screen is a screen indirectly used for operation of the navigation device.

In FIG. 6 to FIG. 8, display of an operation screen of one operation target device is illustrated. However, if a plurality of operation target devices are present, operation screens of a plurality of operation target devices are displayed on the display device(s) 21 at the same time. In this case, the plurality of operation screens may be displayed on one display device 21, or may be displayed on different display devices 21.

<B-2. Processing of Identifying Operation Target Device>

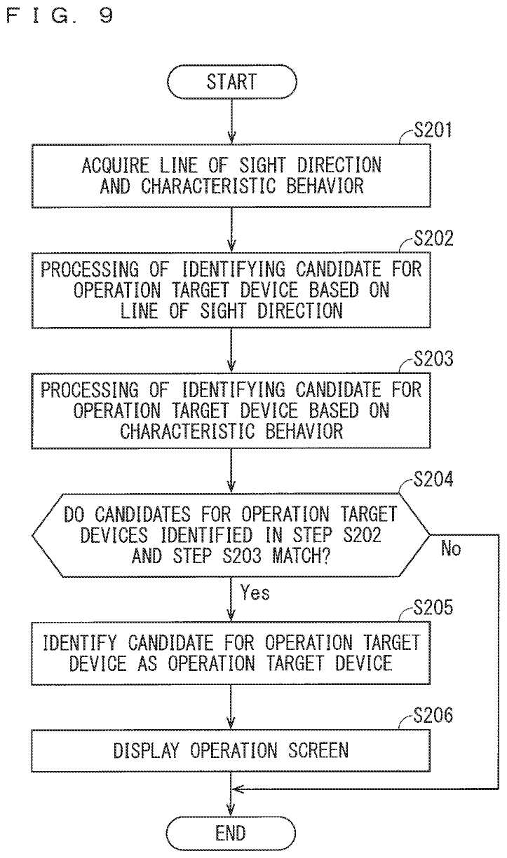

Next, operation of the operation support device 102 will be described, according to the flow of FIG. 9.

First, the line of sight direction acquisition unit 11 acquires a line of sight direction of a driver, and the characteristic behavior acquisition unit 12 acquires a characteristic behavior of the driver (Step S201). Here, the acquired line of sight direction of the driver need not necessarily be a line of sight direction at the same time point as the time point when the characteristic behavior is performed, and may be a line of sight direction within a predetermined period of time preceding or following the time point when the characteristic behavior is performed.

Next, the device identification unit 13 performs processing of identifying a candidate for an operation target device based on the line of sight direction (Step S202). When the driver attempts to operate a specific on-board device 22, the driver sees the on-board device 22 or displayed information of the on-board device 22. For example, when displayed information of a navigation device is displayed on another display device, the driver sees displayed information displayed on the another display device when the driver attempts to operate the navigation device. Accordingly, when the on-board device 22 or displayed information of the on-board device 22 is a line of sight target of the driver, it is likely that the on-board device 22 is identified as an operation target device.

Therefore, when the on-board device 22 or displayed information of the on-board device 22 overlaps the line of sight direction of the driver, the device identification unit 13 identifies the on-board device 22 as a candidate for an operation target device. The device identification unit 13 stores disposition information indicating where in the vehicle interior the on-board devices 22 are mounted. Based on the disposition information, the device identification unit 13 determines whether or not the line of sight direction of the driver overlaps an on-board device 22. Further, the device identification unit 13 occasionally acquires, from the display controller 14, display disposition information indicating which display device 21 and where in the display device 21 the displayed information of the on-board devices 22 is displayed. Based on the display disposition information, the device identification unit 13 determines whether or not the line of sight direction of the driver overlaps displayed information of an on-board device 22. If neither of the whole on-board devices 22 nor displayed information of the whole on-board devices 22 overlaps the line of sight direction of the driver, the device identification unit 13 cannot identify a candidate for an operation target device.

Next, the device identification unit 13 performs processing of identifying a candidate for an operation target device based on the characteristic behavior (Step S203). Specifically, if the characteristic behavior is a finger pointing behavior, the device identification unit 13 identifies an on-board device 22 whose device itself or displayed information of the device overlaps the finger pointing direction of the driver as a candidate for an operation target device. Further, if the characteristic behavior is speaking, the device identification unit 13 identifies an on-board device 22 whose device is associated with a keyword included in the speaking as a candidate for an operation target device. For example, if the driver speaks “I want to turn down the volume”, an audio device associated with the keyword “volume” is identified as a candidate for an operation target device. Further, if the characteristic behavior is a gesture of the driver, the device identification unit 13 identifies an on-board device 22 associated with the gesture as a candidate for an operation target device. Further, if the characteristic behavior is a face direction, the device identification unit 13 identifies an on-board device 22 whose device itself or displayed information of the device overlaps the face direction as a candidate for an operation target device.

Next, the device identification unit 13 determines whether or not the candidate for an operation target device identified in Step S202 and the candidate for an operation target device identified in Step S203 match (Step S204). If a candidate for an operation target device is not identified in either or both of Step S202 and Step S203, as well as if both the candidates do not match, the processing proceeds to No in Step S204. In this case, the operation support device 102 ends the processing without identifying an operation target device.

On the other hand, the candidate for an operation target device identified in Step S202 and the candidate for an operation target device identified in Step S203 match, the device identification unit 13 identifies the matching candidate as an operation target device (Step S205). Then, the display controller 14 creates an operation screen of the operation target device, and causes the display device 21 to display the operation screen (Step S206). This ends the processing of the operation support device 102.

The flow of FIG. 9 illustrates a simple example in which an on-board device 22 overlapping the line of sight direction is identified as a candidate for an operation target device. However, in actuality, the line of sight direction may not thoroughly overlap a specific on-board device 22, or may cover and overlap a plurality of on-board devices 22. Thus, it may be difficult to identify one on-board device 22 as a candidate for an operation target device. Therefore, instead of judging each on-board device 22 among two choices as to whether or not the on-board device 22 is to be identified as a candidate for an operation target device, the device identification unit 13 may calculate probability (operation target probability) that the on-board device 22 is identified as an operation target device.

FIG. 10 illustrates a flowchart of the operation support device 102 when an operation target device is identified based on operation target probability. In the flow of FIG. 10, first, the line of sight direction acquisition unit 11 acquires a line of sight direction of a driver, and the characteristic behavior acquisition unit 12 acquires a characteristic behavior of the driver (Step S301). Step S301 is similar to Step S201 of FIG. 9.

Next, the device identification unit 13 calculates operation target probability X1 of each on-board device 22, based on the line of sight direction (Step S302). In Step S302, if the line of sight direction covers and overlaps a plurality of on-board devices 22, an on-board device 22 having a larger overlapping degree is calculated to have higher operation target probability. Further, if the line of sight direction does not overlap any on-board device 22, an on-board device 22 located closer to the line of sight direction is calculated to have higher operation target probability. Such calculations are in reference to calculation of operation target probability based on a relationship between a device itself of an on-board device 22 and a line of sight direction. However, the same calculation applies to calculation of operation target probability based on a relationship between displayed information of an on-board device 22 and a line of sight direction.

Next, the device identification unit 13 calculates operation target probability X2 of each on-board device 22, based on the characteristic behavior (Step S303).

Then, for each on-board device 22, the device identification unit 13 combines the operation target probability X1 based on the line of sight direction and operation target probability X2 based on the characteristic behavior, and calculates operation target probability X of each on-board device 22 (Step S304). For example, an average value of X1 and X2 may be used as the operation target probability X.

Then, the device identification unit 13 identifies an operation target device, based on the operation target probability X (Step S305). A detailed flow of this step is illustrated in FIG. 11.

In the flow of FIG. 11, first, the device identification unit 13 determines whether or not a maximum value of the operation target probability X of the on-board device 22 is equal to or larger than a (Step S3051). If the maximum value of the operation target probability X is equal to or larger than a, the device identification unit 13 identifies the on-board device 22 having the maximum value of the operation target probability X as an operation target device (Step S3052).

If the maximum value of the operation target probability X is less than a, the device identification unit 13 determines whether or not the maximum value of the operation target probability X is equal to or larger than b (Step S3053). Here, a>b. If the maximum value of the operation target probability X is less than b, the device identification unit 13 ends Step S305 without identifying an operation target device.

If the maximum value of the operation target probability X is equal to or larger than b, the device identification unit 13 determines whether or not the second highest operation target probability X of an on-board device 22 is equal to or larger than c (Step S3054). Here, a>b>c. If the second highest operation target probability X of an on-board device 22 is less than c, the device identification unit 13 ends Step S305 without identifying an operation target device.

If the second highest operation target probability X of an on-board device 22 is equal to or larger than c, the device identification unit 13 identifies two on-board devices 22 having the two highest operation target probabilities X in descending order as operation target devices (Step S3055). This ends Step S305.

Description returns back to the flow of FIG. 10. For the operation target devices identified in Step S305, the display controller 14 creates operation screens, and causes the display device 21 to display the operation screens. Note that, although illustration is omitted in the flow of FIG. 10, if no operation target device is identified in Step S305, no operation screen is displayed in Step S306.

<B-3. Display of Operation Screen>

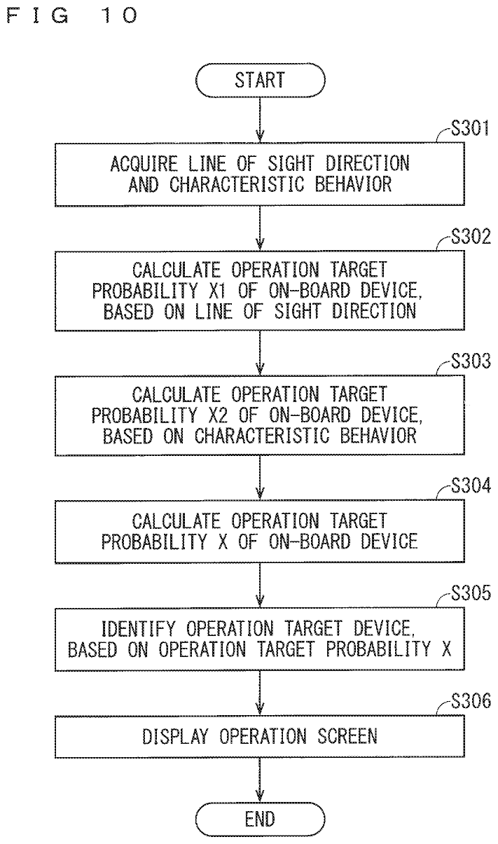

As illustrated in Step S3055 of FIG. 11, when two operation target devices are identified, operation screens are displayed on the display device 21, for those two operation target devices. FIG. 12 illustrates a state in which operation screens of a navigation device and an audio device are displayed on the display device 21 when the navigation device and the audio device are operation target devices. On the display device 21, a map screen around a subject vehicle position 36 being displayed information of the navigation device, a track screen 37 being displayed information of the audio device, an operation menu screen 38 being an operation screen of the audio device, and an operation menu screen 39 being an operation screen of the navigation device are displayed.

In FIG. 12, the reason why the operation menu screen 38 of the audio device is displayed to be larger than the operation menu screen 39 of the navigation device is that the operation target probability X of the audio device is higher than the operation target probability X of the navigation device. In this manner, when a plurality of operation screens are displayed on the display device 21, it is desirable that an operation screen of an operation target device having higher operation target probability X be displayed to be more conspicuous than the other operation screen(s). With this configuration, an operation screen of an on-board device 22 that the driver is more likely to desire to operate can be displayed noticeable to the driver. Note that the display controller 14 may provide a difference in display manners of two operation screens with the degree of clarity, presence or absence of color display, presence or absence of lighting-up, for example, besides the size of a screen.

FIG. 12 illustrates a case where operation screens of a plurality of operation target devices are displayed. However, when one operation target device is identified, the display controller 14 may cause the display device 21 to display both of an operation screen of the operation target device and an operation screen of an on-board device 22 that is not an operation target device. Here, the on-board device 22 whose operation screen is displayed may be an on-board device 22 that is disposed at a position adjacent to the operation target device, or may be an on-board device 22 whose displayed information is displayed at a position adjacent to displayed information of the operation target device on the screen of the display device 21. With this configuration, an operation screen of an on-board device 22 that the user may desire to operate can be displayed even when the on-board device 22 is not identified as an operation target device. Also in this case, an operation screen of an on-board device 22 that the driver is likely to desire to operate can be displayed noticeable to the driver by displaying an operation screen of the operation target device to be more conspicuous than an operation screen of an on-board device 22 that is not an operation target device.

If a plurality of display devices 21 are present, the display controller 14 selects one display device 21, and causes the selected display device 21 to display operation screen(s).

For example, the display controller 14 can cause a display device 21 located closest to the line of sight direction of the driver that is used when the device identification unit 13 identifies an operation target device to display operation screen(s). With this configuration, the driver can visually recognize the operation screen(s) without significantly moving the line of sight direction when the driver selects an operation target device from the on-board devices 22.

Alternatively, the display controller 14 may classify the on-board devices 22 into a device related to controlled traveling, a device related to the body, and a device related to information, and may cause a display device 21 suited for the classification of operation target devices to display operation screen(s). The device related to controlled traveling refers to a device that performs control related to traveling of a vehicle, such as auto-cruise and auto-braking. The device related to the body refers to a device that performs control related to the body of a vehicle, such as a window and a door. The device related to information refers to a device that provides information to a passenger of a vehicle, such as a navigation device and an audio device.

Then, for example, the display controller 14 may cause the HUD to display operation screen(s) of the device related to controlled traveling, and cause the CID to display operation screen(s) of the device related to the body and the device related to information. With this configuration, the driver can safely perform operation on operation screen(s) of the device related to controlled traveling that is related to traveling of a vehicle while the driver drives the vehicle.

<B-4. Operation Device>

Next, operation of the operation screen will be described. The driver can operate an operation screen displayed on the display device 21 by using the operation device 25. The operation receiver 15 acquires operation information of the operation device 25, and outputs the operation information to the display controller 14 and the operation target device controller 16.

Based on the operation information of the operation device 25 acquired from the operation receiver 15, the display controller 14 updates the operation screen and causes the display device 21 to display the operation screen.

Based on the operation information of the operation device 25 acquired from the operation receiver 15, the operation target device controller 16 performs control of an operation target device.

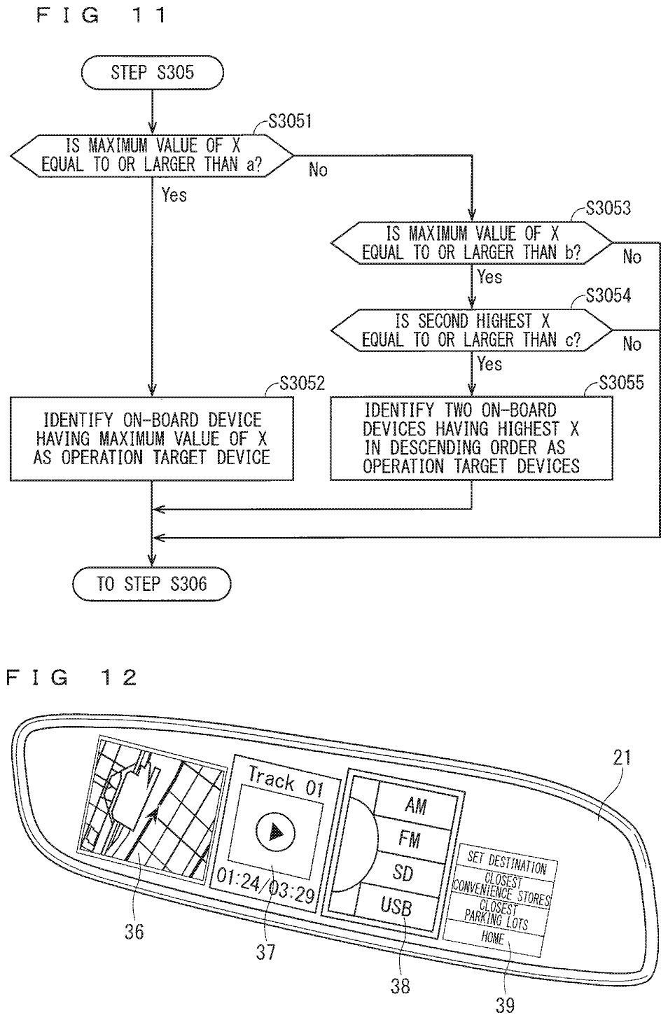

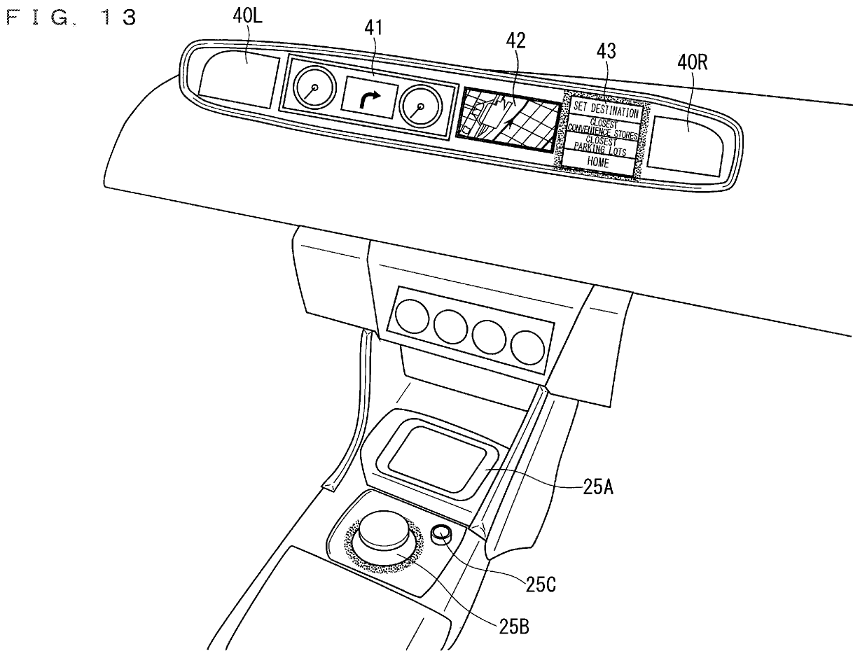

FIG. 13 is a diagram illustrating the display device 21 and the operation device 25. In FIG. 13, a touch pad 25A, a dial 25B, and a button 25C are provided in a console between a driver's seat and a front passenger seat, and these components correspond to the operation device 25. In the display device 21, a left mirror image 40L, a right mirror image 40R, a meter display 41, a map screen around a subject vehicle position 42 being displayed information of the navigation device, and an operation screen 43 of the navigation device are displayed. The navigation device is an operation target device.

Here, it is determined in advance that the operation device 25 for operating the operation screen 43 of the navigation device is the dial 25B. In this case, the operation target device controller 16 lights up the dial 25B. With this configuration, the driver can easily notice the operation device 25 used for operation of the operation screen 43.

Further, in addition to lighting up the dial 25B, the display controller 14 may light up the operation screen 43 of the navigation device. With this configuration, the driver can more easily notice the operation device 25 used for operation of the operation screen 43.

Further, the same light up color may be used for the dial 25B and the operation screen 43, so that the driver can more easily notice the operation device 25 used for operation of the operation screen 43.

Further, the display controller 14 may change light up colors depending a type of an operation screen, such as by using blue for an operation screen of the navigation device and red for an operation screen of the audio device, so that the driver can easily know operation details of the operation screen.

Further, the display controller 14 may perform various light up displays depending on a type of the operation device 25, such as by performing light up display that light repeatedly moves around the dial 25B when the display controller 14 performs light up display for the dial 25B, and by causing the button 25C to flicker when the display controller 14 performs light up display for the button 25C. With this configuration, the driver can easily know how to operate the operation device 25.

<B-5. Examples of Characteristic Behavior of Driver>

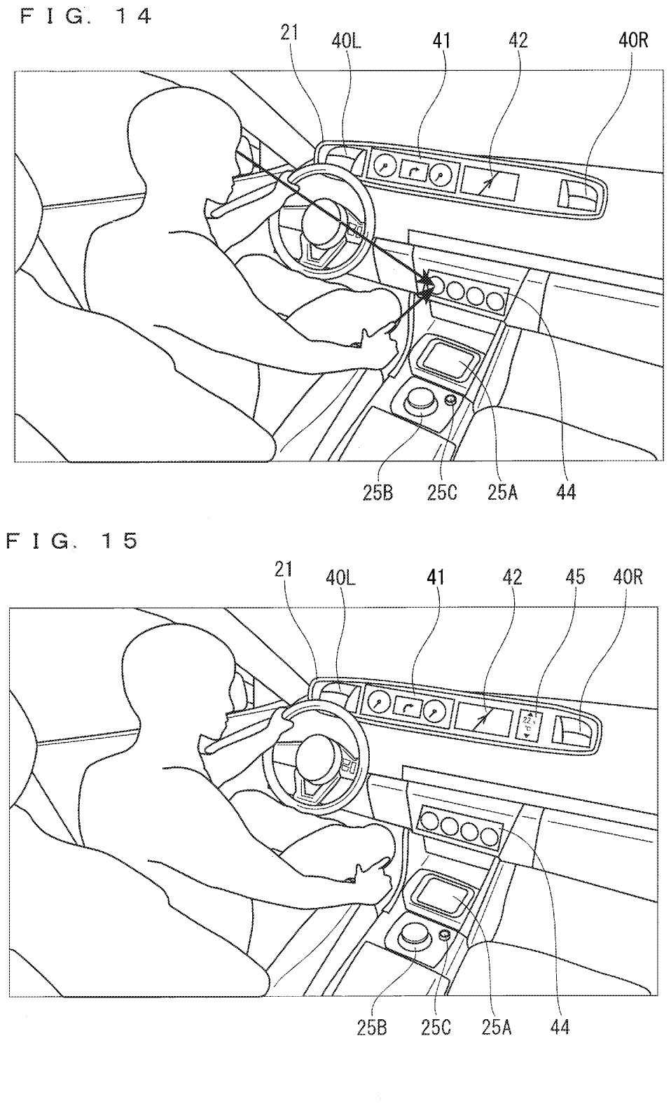

Next, examples of characteristic behavior of the driver are illustrated. FIG. 14 illustrates a state in which the driver points an air conditioner operation device 44 with a right index finger while the driver sees the air conditioner operation device 44, In this case, based on a line of sight direction of the driver and a pointing direction of the index finger, the device identification unit 13 identifies an air conditioner as an operation target device, through the processing described in <B-2>. Then, as illustrated in FIG. 15, the display controller 14 displays an operation screen 45 of the air conditioner on the display device 21. The user operates the operation screen 45 by using the operation device 25, such as the touch pad 25A or the dial 25B. In this manner, the operation target device controller 16 performs control of the air conditioner.

FIG. 16 illustrates a state in which the driver speaks “I want to turn down the volume a little” while the driver sees a track screen 46 being displayed information of the audio device. In this case, based on a line of sight direction of the driver and details of the speaking of the driver, the device identification unit 13 identifies the audio device as an operation target device, through the processing described in <B-2>. Then, as illustrated in FIG. 17, the display controller 14 displays a volume operation screen 47 of the audio device on the display device 21. The user operates the volume operation screen 47 by using the operation device 25, such as the touch pad 25A or the dial 27B. In this manner, the operation target device controller 16 performs control on the audio device to turn down the volume. Note that, in this example, the operation target device controller 16 may perform control of the volume of the audio device by one level or by several levels without waiting for the driver to perform operation on the volume operation screen 47.

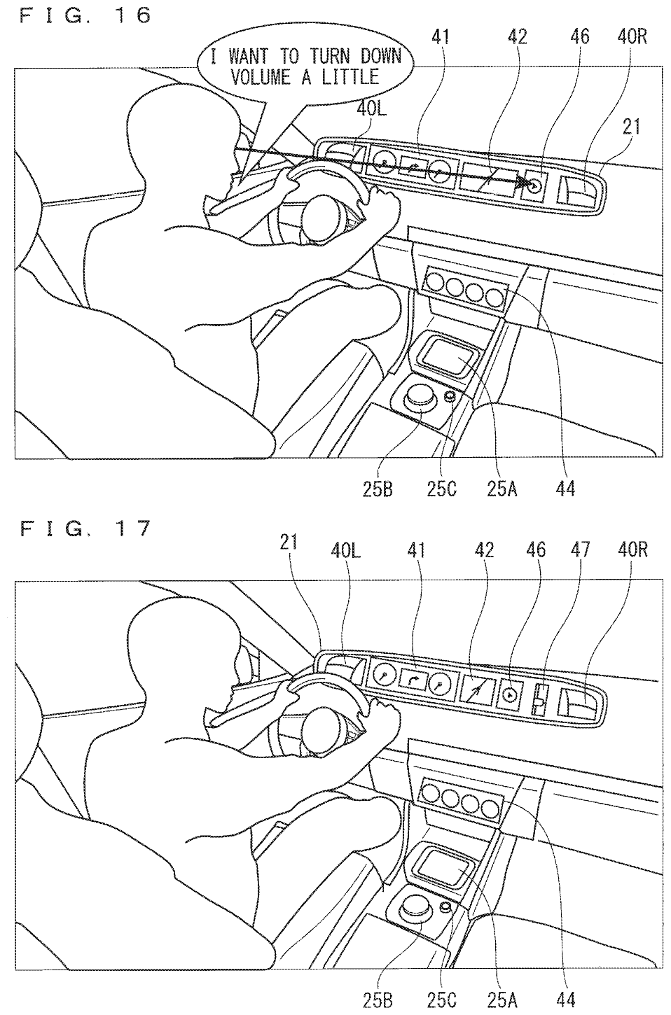

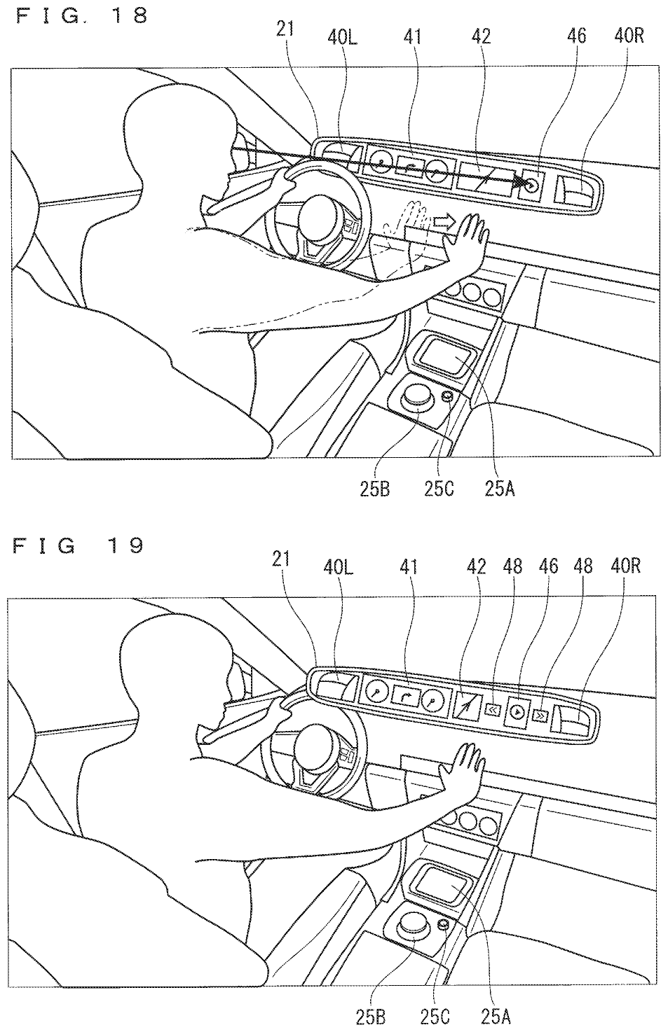

FIG. 18 illustrates a state in which the driver makes a gesture of moving a palm of a hand brought forward from left to right, i.e., performs swipe operation, while the driver sees the track screen 46 being displayed information of the audio device. In this case, based on a line of sight direction of the driver and the swipe operation, the device identification unit 13 identifies the audio device as an operation target device, through the processing described in <B-2>. Then, as illustrated in FIG. 19, the display controller 14 displays a track skip forward/backward screen 48 of the audio device on the display device 21. The user operates the track skip forward/backward screen 48 by using the operation device 25, such as the touch pad 25A or the dial 25B. In this manner, the operation target device controller 16 controls the audio device to skip a track forward or backward. Note that, in this example, the operation target device controller 16 may control the audio device to skip a track to the next track without waiting for the driver to perform operation on the track skip forward/backward screen 48.

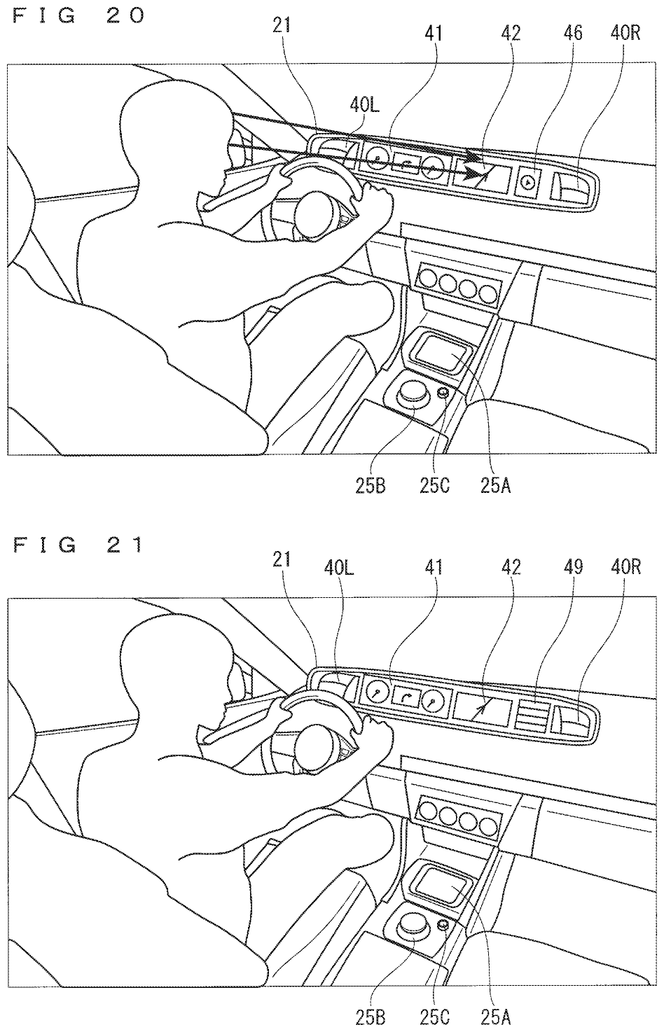

FIG. 20 illustrates a state in which the driver turns his/her face to the map screen around a subject vehicle position 42 while the driver sees the map screen around a subject vehicle position 42 being displayed information of the navigation device. In this case, based on a line of sight direction of the driver and the face direction, the device identification unit 13 identifies the audio device as an operation target device, through the processing described in <B-2>. Then, as illustrated in FIG. 21, the display controller 14 displays an operation menu 49 for the navigation device on the display device 21. The user operates the operation menu 49 by using the operation device 25, such as the touch pad 25A or the dial 25B. In this manner, the operation target device controller 16 performs predetermined control on the navigation device.

As described in the above examples, the operation support device 102 of the second example identifies an operation target device, based on both the line of sight direction and the characteristic behavior, and can therefore accurately identify an operation target device. If a plurality of on-board devices 22 are disposed adjacent to each other, the line of sight direction may overlap a plurality of on-board devices 22. Further, the line of sight direction may move while covering a plurality of on-board devices 22, due to the sway of the vehicle. In such a case, it is difficult to identify an operation target device, based only on the line of sight direction. However, an operation target device can be accurately identified by using the characteristic behavior and thereby compensating for accuracy of identifying an operation target device.

<B-6. Effect>

According to the operation support device 102 of the second embodiment, the device identification unit 13 identifies at least one on-board device out of the plurality of on-board devices 22 as a candidate for the operation target device, based on the line of sight direction, and identifies at least one on-board device 22 out of the plurality of on-board devices 22 as a candidate for the operation target device, based on the characteristic behavior. If the candidate for the operation target device identified based on the line of sight direction and the candidate for the operation target device identified based on the characteristic behavior match, the device identification unit 13 identifies the candidate for the operation target device as the operation target device. Therefore, according to the operation support device 102, the operation target device can be accurately identified.

In addition to the configuration of the operation support device 101 of the first embodiment, the operation support device 102 further includes an operation receiver 15, and an operation target device controller 16. The operation receiver 15 is configured to acquire operation information of a plurality of operation devices 25 mounted in the vehicle and operated by the driver. The operation target device controller 16 is configured to control the operation target device, based on the operation information. The display controller 14 changes the operation screen of the operation target device, based on the operation information. Therefore, according to the operation support device 102, the operation screen of the operation target device can be displayed, and the operation screen can be used for driver's operation.

Further, in the operation support device 102, the device identification unit 13 identifies the operation target device, based on an overlapping degree between the line of sight direction of the driver and the on-board device. Therefore, the driver can cause the display device 21 to display an operation screen of a device by seeing the device that the driver desires to operate.

Further, in the operation support device 102, the display controller 14 causes the display device 21 to display respective pieces of displayed information of a plurality of operable devices. The device identification unit 13 identifies the operation target device, based on an overlapping degree between the displayed information and the line of sight direction of the driver. Therefore, the driver can cause the display device 21 to display an operation screen of a device by seeing displayed information of the device that the driver desires to operate on a display screen of the display device 21.

Further, in the operation support device 102, the operation target device controller 16 lights up the operation device 25 used to change the operation screen. Therefore, according to the operation support device 102, the operation device 25 used for operation of the operation screen 43 can be easily notified to the driver.

Further, in the operation support device 102, the device identification unit 13 calculates operation desired probability, based on the line of sight direction and the characteristic behavior, and identifies the operation target device, based on the operation desired probability. The operation desired probability is probability that the driver desires to operate each of the plurality of on-board devices 22. If a plurality of the operation target devices are present, the display controller 14 displays the operation screen of the operation target device having higher operation desired probability to be more conspicuous. Therefore, according to the operation support device 102, the operation screen of the on-board device 22 that the user may desire to operate can be appropriately displayed.

Further, in the operation support device 102, the display controller 14 causes the display device 21 to display an operation screen of the on-board device 22 that is located adjacent to the operation target device and that is not the operation target device to be less conspicuous than an operation screen of the operation target device. Therefore, an operation screen of the operation target device that the driver is more likely to desire to operate can be displayed noticeable to the driver while the operation screen of the on-board device 22 that the driver may desire to operate is displayed.

### C. Third Embodiment

<C-1. Configuration>

In the second embodiment, the characteristic behavior is used as compensation for the line of sight direction, for the purpose of identifying an operation target device. In contrast, in a third embodiment, the characteristic behavior is used to determine a timing of identifying an operation target device, based on the line of sight direction.

A configuration of an operation support device 103 according to the third embodiment is as illustrated in FIG. 3, and is the same as the configuration of the operation support device 102 according to the second embodiment.

<C-2. Operation>

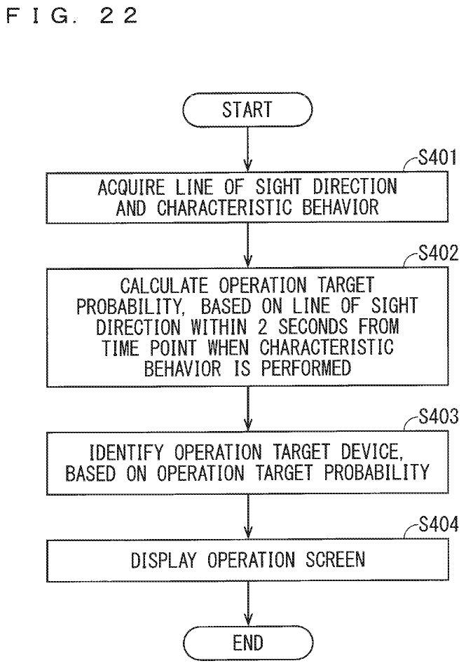

FIG. 22 is a flowchart illustrating operation of the operation support device 103. Operation of the operation support device 103 will be described below, according to the flow of FIG. 22.

In the flow of FIG. 22, first, the line of sight direction acquisition unit 11 acquires a line of sight direction of a driver, and the characteristic behavior acquisition unit 12 acquires a characteristic behavior of the driver (Step S401). This step is the same as Step S201 of FIG. 9 or Step S301 of FIG. 10.

Next, the device identification unit 13 calculates operation target probability of each on-board device 22, based on the line of sight direction within a predetermined period of time, e.g., 2 seconds, from the time point when the characteristic behavior is performed (Step S402). A method of calculating the operation target probability based on the line of sight direction is as described in the second embodiment.

Next, the device identification unit 13 identifies an operation target device, based on the operation target probability of each on-board device 22 (Step S403). Here, the device identification unit 13 identifies one or more on-board devices having the highest operation target probabilities in descending order as operation target device(s). Details of an identification method are as described in the flow of FIG. 11 in the second embodiment.

Next, the display controller 14 creates operation screen(s) of the operation target device(s), and causes the display device 21 to display the operation screen(s) (Step S404). This step is the same as Step S206 of FIG. 9 or Step S306 of FIG. 10.

In this manner, in the third embodiment, the characteristic behavior is not a direct element for identifying an operation target device, but is used to determine a timing for identifying an operation target device, based on the line of sight direction. In the example described above, when the driver sees a certain on-board device 22 within a certain period of time (e.g., 2 seconds) following the time point when the characteristic behavior is performed, the on-board device 22 is identified as an operation target device.

However, the line of sight direction used to calculate operation target probability need not be a line of sight direction within a predetermined period of time following the time point when a characteristic behavior is performed, and may be a line of sight direction within a predetermined period of time preceding the time point when a characteristic behavior is performed. In this case, when a characteristic behavior is performed after the driver sees a certain on-board device 22 for a certain period of time (e.g., 2 seconds), the on-board device 22 is identified as an operation target device.

Further, FIG. 22 illustrates a method of identifying an operation target device, based on operation target probability. However, an on-board device 22 overlapping a line of sight direction may be identified as an operation target device, with a method similar to the method described in the flow of FIG. 9 in the second embodiment.

<C-3. Effect>

In the operation support device 103 of the third embodiment, the device identification unit 13 identifies the operation target device, based on the line of sight direction of the driver within a predetermined period of time preceding or following a time point when the characteristic behavior is performed. In this manner, the operation support device 103 can accurately identify an operation target device by identifying an operation target device with the line of sight direction at a timing determined based on the characteristic behavior.

### D. Fourth Embodiment

<D-1. Configuration>

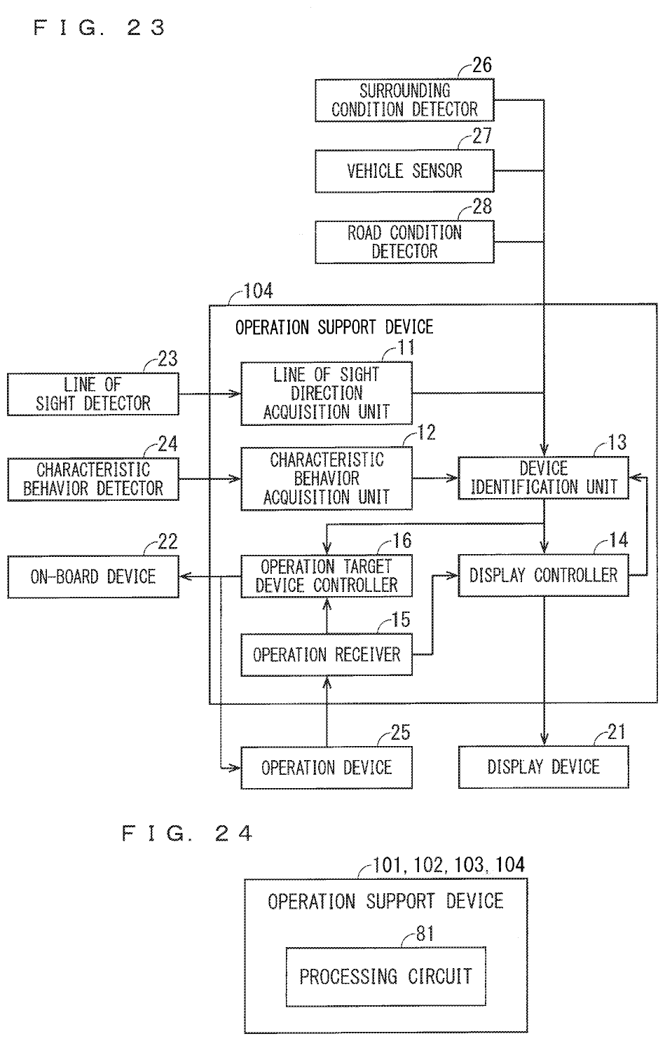

FIG. 23 is a block diagram illustrating a configuration of an operation support device 104 according to a fourth embodiment. The configuration of the operation support device 104 is similar to the configuration of the operation support device 102 or 103 of the second embodiment or the third embodiment illustrated in FIG. 3. Note that the operation support device 104 is different from the operation support devices 102 and 103 in that the operation support device 104 is connected to a surrounding condition detector 26, a vehicle sensor 27, and a road condition detector 28, and is configured to be capable of using these connected components. The surrounding condition detector 26, the vehicle sensor 27, and the road condition detector 28 are devices mounted in the vehicle.

Similarly to the embodiments described above, the device identification unit 13 identifies an operation target device, based on a line of sight direction and a characteristic behavior of a driver. At the time of identifying an operation target device, the device identification unit 13 considers an overlapping degree between an on-board device 22 or displayed information of the on-board device 22 and the line of sight direction of the driver. Typically, an on-board device 22 that overlaps the line of sight direction of the driver is identified as an operation target device.

Although particular reference is not made in the second and third embodiments, the line of sight direction of the driver used to identify the operation target device described above is not an instantaneous line of sight direction, but is a line of sight direction during a certain continuous period of time. This “certain continuous period of time” is referred to as a “gaze detected period of time”.

In the fourth embodiment, the device identification unit 13 variably sets the gaze detected period of time, depending on presence or absence of traveling of a vehicle, a type of a traveling road, and a condition of a nearby vehicle, for example.

The surrounding condition detector 26 includes a camera, a radar, or the like mounted in the vehicle, and detects a traveling condition of a nearby vehicle. The nearby vehicle refers to a vehicle that travels around the subject vehicle. Examples of the traveling condition of a nearby vehicle include a traveling speed of the nearby vehicle, and a distance between the nearby vehicle and the subject vehicle.

The vehicle sensor 27 is a sensor that detects a condition of a vehicle in which the sensor is mounted, and for example, a vehicle speed sensor is included in the vehicle sensor 27. The device identification unit 13 can determine whether the vehicle is traveling or stopping, based on detected information of the vehicle sensor.

For example, the road condition detector 28 calculates the position of the vehicle by using signals of the Global Positioning System (GPS) or the like, and refers to map information to detect a type of a road on which the vehicle currently travels. For example, the type of a traveling road is a type whether a road is a general road or a freeway.

Information from the surrounding condition detector 26, the vehicle sensor 27, and the road condition detector 28 is information indicating how much time the driver can gaze an on-board device 22. For example, the driver concentrates more on driving during traveling of the vehicle as compared to the time when the vehicle is stopping, and thus the driver cannot gaze an on-board device 22 for a long period of time. Further, it is considered that a concentration load on driving is larger in a freeway as compared to a general road, and the driver cannot gaze an on-board device 22 for a long period of time. Further, it is considered that, when a nearby vehicle is traveling around, a driving load is larger as compared to the time when there is no nearby vehicle, and thus the driver cannot gaze an on-board device 22 for a long period of time. In view of such conditions, for example, the device identification unit 13 sets the gaze detected period of time to 500 ms or more and 1500 ms or less when the vehicle is traveling in a general road, and to 2000 ms or more and 3000 ms or less when the vehicle is stopping.

With this configuration, erroneous detection of an operation target device is less liable to be caused, and the driver may not be required to gaze an on-board device 22 for a long period of time to the extent possible.

<D-2. Effect>

In the operation support device 104 of the fourth embodiment, the device identification unit 13 identifies the operation target device, based on the line of sight direction during a gaze detected period of time. The gaze detected period of time varies depending on at least any of presence or absence of traveling of the vehicle, a type of a traveling road, and a condition of a nearby vehicle traveling around the vehicle. Therefore, according to the operation support device 104, driving safety is considered, and erroneous detection of an operation target device can be less liable to be caused.

### E. Hardware Configuration

The line of sight direction acquisition unit 11, the characteristic behavior acquisition unit 12, the device identification unit 13, the display controller 14, the operation receiver 15, and the operation target device controller 16 in the operation support devices 101, 102, 103, and 104 described above are implemented by a processing circuit 81 illustrated in FIG. 24. Specifically, the processing circuit 81 includes the line of sight direction acquisition unit 11, the characteristic behavior acquisition unit 12, the device identification unit 13, the display controller 14, the operation receiver 15, and the operation target device controller 16 (hereinafter simply referred to as “line of sight direction acquisition unit 11 etc.”). As the processing circuit 81, dedicated hardware may be used, or a processor to execute a program stored in memory may be used. Examples of the processor include a central processing unit, a processing unit, an arithmetic unit, a microprocessor, a microcomputer, and a digital signal processor (DSP).

If the processing circuit 81 is dedicated hardware, examples of the processing circuit 81 include a single circuit, a composite circuit, a programmed processor, a processor for parallel programming, an application specific integrated circuit (ASIC), and a field-programmable gate array (FPGA), or a combination of these. The function of each part of the line of sight direction acquisition unit 11 etc. may be implemented by a plurality of processing circuits 81, or the functions of individual parts may be collectively implemented by one processing circuit.

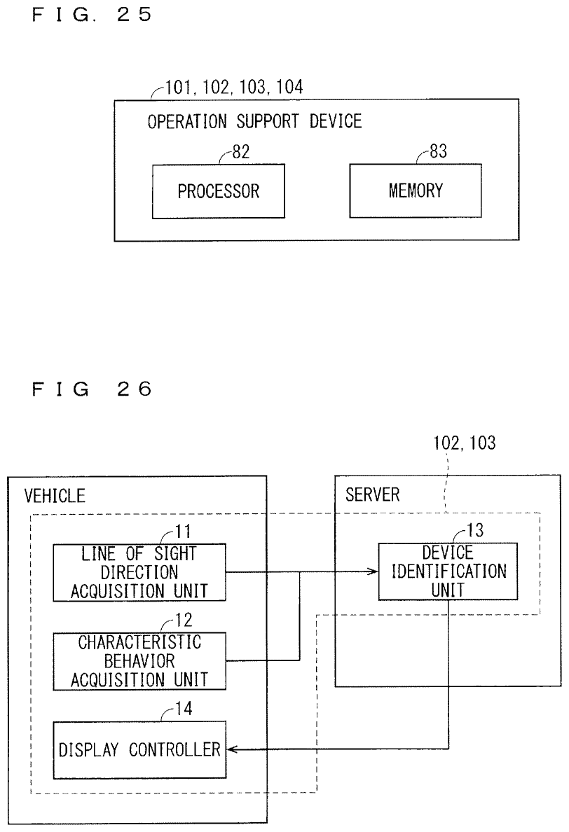

If the processing circuit 81 is a processor, the functions of the line of sight direction acquisition unit 11 etc. are implemented by a combination with software etc. (software, firmware, or software and firmware). The software etc. are described as a program, and are stored in memory. As illustrated in FIG. 25, a processor 82 used in the processing circuit 81 reads out and executes a program stored in memory 83 to implement a function of each part. Specifically, the operation support devices 101, 102, 103, and 104 include the memory 83 for storing the program that eventually executes a step of determining a line of sight direction of a driver of a vehicle, a step of acquiring a characteristic behavior being a characteristic behavior of the driver other than a line of sight, a step of identifying at least one on-board device 22 out of a plurality of on-board devices 22 mounted in the vehicle as an operation target device that the driver desires to operate, based on the line of sight direction and the characteristic behavior, and a step of causing a display device 21 mounted in the vehicle to display an operation screen of the operation target device, when the program is executed by the processing circuit 81. In other words, it can be said that the program makes a computer execute a procedure and a method of the line of sight direction acquisition unit 11 etc. Here, examples of the memory 83 may include a non-volatile or volatile semiconductor memory, such as random access memory (RAM), read only memory (ROM), flash memory, erasable programmable read only memory (EPROM), and electrically erasable programmable read only memory (EEPROM), a hard disk drive (HDD), a magnetic disk, a flexible disk, an optical disc, a compact disc, a MiniDisc, a digital versatile disk (DVD), a drive device of these components, and any storage medium that may be used ahead.

In the above, a configuration in which each function of the line of sight direction acquisition unit 11 etc. is implemented by any one of hardware and software etc. is described. However, the configuration is not limited to the above, and a configuration in which a part of the line of sight direction acquisition unit 11 etc. is implemented by dedicated hardware and another part is implemented by software etc. may be adopted. For example, the function of the device identification unit 13 may be implemented by a processing circuit as dedicated hardware. The function of other parts may be implemented by the processing circuit 81 as the processor 82 reading out and executing the program stored in the memory 83.

In this manner, the processing circuit may implement the above-mentioned each function by hardware, software etc., or a combination of these.

Further, in the above, the operation support devices 101, 102, 103, and 104 are described as devices mounted in a vehicle, However, the operation support devices 101, 102, 103, and 104 may also be used in a system constructed as a system achieved by appropriately combining a device mounted in a vehicle, a portable navigation device (PND), a communication terminal (e.g., a mobile terminal such as a mobile phone, a smartphone, and a tablet), a function of an application installed in these devices, and a server, for example. In this case, each function or each component of the operation support devices 101, 102, 103, and 10 described above may be distributed in each device that constructs the system, or may be centralized in any of the devices. FIG. 26 illustrates an example in which the configurations of the operation support devices 102 and 103 are separately distributed in a vehicle and a server. In this example, the line of sight direction acquisition unit 11, the characteristic behavior acquisition unit 12, and the display controller 14 are mounted in a vehicle, and the device identification unit 13 is configured by a server.

Note that, in the present invention, each embodiment can be freely combined, and each embodiment can be modified or omitted as appropriate, within the scope of the invention.

While the invention has been shown and described in detail, the foregoing description is in all aspects illustrative and not restrictive. It is therefore understood that numerous unillustrated modifications and variations can be devised without departing from the scope of the invention.

### EXPLANATION OF REFERENCE SIGNS

11 line of sight direction acquisition unit, 12 characteristic behavior acquisition unit, 13 device identification unit, 14 display controller, 15 operation receiver, 16 operation target device controller, 21 display device, 21A meter display, 21B HUD, 21C CID, 21D front passenger seat display, 22 on-board device, 23 line of sight detector, 24 characteristic behavior detector, 24A fingertip direction detector, 24B voice input device, 24C gesture detector, 24D face direction detector, 25 operation device, 25A touch pad, 25B dial, 25C button, 26 surrounding condition detector, 27 vehicle sensor, 81 processing circuit, 82 processor, 83 memory, 101, 102, 103, 104 operation support device

1-11. (canceled)

12. An operation support device comprising:
a processor to execute a program; and
a memory to store the program which, when executed by the processor, performs processes of:
acquiring a line of sight direction of a driver of a vehicle;
acquiring a characteristic behavior being a characteristic behavior of the driver other than a line of sight;
identifying at least one on-board device out of a plurality of on-board devices mounted in the vehicle as an operation target device that the driver desires to operate, based on the line of sight direction and the characteristic behavior; and
causing a display device mounted in the vehicle to display an operation screen of the operation target device, wherein
the characteristic behavior is at least any of finger pointing, a gesture, and speaking of the driver.

13. The operation support device according to claim 12, wherein
identification of the operation target device is identification of at least one on-board device out of the plurality of on-board devices as a candidate for the operation target device, based on the line of sight direction, identification of at least one on-board device out of the plurality of on-board devices as a candidate for the operation target device, based on the characteristic behavior, and identification of the candidate for the operation target device as the operation target device if the candidate for the operation target device identified based on the line of sight direction and the candidate for the operation target device identified based on the characteristic behavior match.

14. The operation support device according to claim 13, wherein
the characteristic behavior is finger pointing of the driver, and
identification of the operation target device is identification of the on-board device whose device itself or displayed information of the device overlaps a finger pointing direction of the driver as the candidate for the operation target device.

15. The operation support device according to claim 13, wherein
the characteristic behavior is speaking of the driver, and
identification of the operation target device is identification of the on-board device associated with a specific keyword included in the speaking as the candidate for the operation target device.

16. The operation support device according to claim 13, wherein
the characteristic behavior is a gesture of the driver, and
identification of the operation target device is identification of the on-board device associated with the gesture as the candidate for the operation target device.

17. The operation support device according to claim 12, wherein
identification of the operation target device is identification of the operation target device, based on the line of sight direction of the driver within a predetermined period of time preceding or following a time point when the characteristic behavior is performed.

18. The operation support device according to claim 12, wherein
the program, when executed by the processor, performs further processes of:
acquiring operation information of a plurality of operation devices mounted in the vehicle and operated by the driver;
controlling the operation target device, based on the operation information; and
changing the operation screen of the operation target device, based on the operation information.

19. The operation support device according to claim 12, wherein
identification of the operation target device is identification of the operation target device, based on an overlapping degree between the line of sight direction of the driver and the on-board device.

20. The operation support device according to claim 12, wherein
the program, when executed by the processor, performs further a process of causing the display device to display displayed information of the plurality of on-board devices, and
identification of the operation target device is identification of the operation target device, based on an overlapping degree between the displayed information and the line of sight direction of the driver.

21. The operation support device according to claim 18, wherein
the program, when executed by the processor, performs further a process of lighting up the operation device used to change the operation screen.

22. The operation support device according to claim 21, wherein
the operation device used to change the operation screen is lit up in different modes between a case where the operation device used to change the operation screen is a dial and a case where the operation device used to change the operation screen is a button.

23. The operation support device according to claim 12, wherein
identification of the operation target device is identification of the operation target device based on operation desired probability, the operation desired probability being probability that the driver desires to operate each of the plurality of on-board devices and being calculated based on the line of sight direction and the characteristic behavior, and
causing the operation screen to be displayed on the display device is causing the operation screen of the operation target device having higher operation desired probability to be displayed to be more conspicuous, if a plurality of the operation target devices are present.

24. The operation support device according to claim 12, wherein
the program, when executed by the processor, performs further a process of causing the display device to display an operation screen of the on-board device that is located adjacent to the operation target device and that is not the operation target device to be less conspicuous than an operation screen of the operation target device.

25. The operation support device according to claim 12, wherein
identification of the operation target device is identification of the operation target device, based on the line of sight direction during a gaze detected period of time, the gaze detected period of time varying depending on at least any of presence or absence of traveling of the vehicle, a type of a traveling road, and a condition of a nearby vehicle traveling around the vehicle.

26. An operation support method comprising the steps of:
determining a line of sight direction of a driver of a vehicle;
acquiring a characteristic behavior being a characteristic behavior of the driver other than a line of sight;
identifying at least one on-board device out of a plurality of on-board devices mounted in the vehicle as an operation target device that the driver desires to operate, based on the line of sight direction and the characteristic behavior; and
causing a display device mounted in the vehicle to display an operation screen of the operation target device.
